(19) United States
(12) Patent Application Publication
(10) Pub. No.: US 2010/0129538 A1
(43) Pub. Date: May 27, 2010

(54) PROCESS FOR PRODUCING MAGNET

(75) Inventors: Ryota Kunieda, Tokyo (JP); Makoto Nakane, Tokyo (JP); Fumitaka Baba, Tokyo (JP); Makoto Iwasaki, Tokyo (JP); Satoshi Tanaka, Tokyo (JP); Hideki Nakamura, Tokyo (JP)

Correspondence Address: DRINKER BIDDLE & REATH (DC), 1500 K STREET, N.W., SUITE 1100, WASHINGTON, DC, 20005-1209, US

(73) Assignee: TDK CORPORATION, CHUO-KU, TK (unknown)

(21) Appl. No.: 12/593,324

(22) PCT Filed: Mar. 31, 2008
(86) PCT No.: PCT/JP2008/056381

§ 371 Date: Oct. 22, 2009

(30) Foreign Application Priority Data
Mar. 30, 2007 (JP) 2007-093457

(51) Int. Cl. H01F 41/02; B05D 5/00

(52) U.S. Cl. 427/127

(57) ABSTRACT

The invention provides a process for producing a magnet that not only allows satisfactory Br and HcJ values to be achieved but can also yield a magnet with a sufficiently large squareness ratio. The process for producing a magnet according to the invention is characterized by comprising a first step in which a heavy rare earth compound containing a heavy rare earth element is adhered onto a rare earth magnet sintered compact, and a second step in which the heavy rare earth compound-adhered sintered compact is subjected to heat treatment. The heavy rare earth compound is a hydride of the heavy rare earth element.

### TECHNICAL FIELD

The present invention relates to a process for producing a magnet, and more specifically it relates to a process for producing a rare earth magnet containing a rare earth element.

### BACKGROUND ART

Rare earth magnets having R—Fe—B (R=rare earth element) systems exhibit excellent magnetic properties, and much research is being devoted to further improving their magnetic properties. Residual flux density (Br) and coercive force (HcJ) are generally used as indices of the magnetic properties of magnets. It is known in the art that the HcJ value of a rare earth magnet can be improved by adding Dy or Tb.

However, since the saturation magnetization of an R—Fe—B based compound is lowered when an element such as Dy or Tb is selected as R, its addition in an excessive amount will tend to reduce the Br value. A method for minimizing this inconvenience has been disclosed in Patent document 1 identified below, wherein a sintered magnet having an R—Fe—B based composition is subjected to heat treatment at a temperature below its sintering temperature while a powder containing an oxide, fluoride or oxyfluoride of a rare earth element is present on its surface. This method produces a magnet with both a high Br and a high HcJ.

[Patent document 1] International Patent Publication No. WO 2006/043348

### DISCLOSURE OF THE INVENTION

### Problems to be Solved by the Invention

Rare earth magnets have been applied for many purposes in recent years because of their high magnetic properties, and they are often used under high temperature conditions in automobile engines, for example. However, research by the present inventors has suggested that rare earth magnets subjected to such treatment in the prior art tend to have severely impaired magnetic properties when used under high-temperature conditions.

We therefore conducted further research on conventional rare earth magnets to determine the cause of the reduced magnetic properties under high temperature, and as a result discovered that, although such rare earth magnets have sufficient Br and HcJ values, there is a significant reduction in flux with respect to the demagnetizing field in the demagnetization curve, and the ratio of the magnetic field value (Hk) when the magnetization is 90% of Br, with respect to HcJ, i.e. the squareness ratio (Hk/HcJ), tends to be low. Such a low squareness ratio tends to reduce the magnetic susceptibility with respect to temperature changes, increasing the degree of irreversible demagnetization, and therefore such magnets are unsuitable for high temperature use.

It is an object of the present invention, which has been accomplished in light of the problems of the prior art described above, to provide a process for producing a magnet that not only allows satisfactory Br and HcJ values to be achieved but can also yield a magnet with a sufficiently large squareness ratio.

### Means for Solving the Problems

As a result of much diligent research by the present inventors aimed at achieving the object stated above, it has been discovered that adhering a compound of a specific rare earth element to a sintered compact provides satisfactory Br and HcJ values while also resulting in a sufficiently large squareness ratio, and the present invention has been completed on the basis of this discovery.

Specifically, the process for producing a magnet according to the invention is characterized by comprising a first step in which a heavy rare earth compound containing a heavy rare earth element is adhered onto a rare earth magnet sintered compact, and a second step in which the heavy rare earth compound-adhered sintered compact is subjected to heat treatment, wherein the heavy rare earth compound is a hydride of the heavy rare earth element. The term “rare earth magnet sintered compact” refers to a sintered compact obtained by firing the starting material (magnetic powder or the like) that is used to form the rare earth magnet.

It is conjectured, though not absolutely determined, that adhering a hydride of a heavy rare earth element to the sintered compact of the rare earth magnet and subjecting it to heat treatment according to the process for producing a magnet according to the invention, causes the heavy rare earth element to be selectively incorporated into the fringe regions and grain boundaries of the main phase particles composing the sintered compact. This is presumed to be the reason for the excellent HcJ of the magnet that is obtained by using the heavy rare earth element, while the adequately high Br is attributed to the fact that the heavy rare earth element is not present in excess in the main phase particles.

According to the invention, using a hydride of a heavy rare earth element as the heavy rare earth compound can increase the range in which flux is maintained against a demagnetizing field and can significantly improve the HcJ, while adequately inhibiting reduction in the squareness ratio that has been notable when using fluorides or the like in the prior art. While the reason for satisfactory maintenance of the squareness ratio by using a hydride is not fully understood, it is conjectured to be as follows. That is, when using a hydride of a heavy rare earth element which is adhered onto a sintered compact and subjected to heat treatment, the heavy rare earth element becomes maldistributed at a high concentration near the grain boundaries of the main phase particles of the sintered compact, thus evenly covering the peripheries of the main phase particles while also shortening the diffusion length inside the main phase particles. Presumably, therefore, the coercive force for each main phase particle is reduced after the heavy rare earth element has been diffused inside the sintered compact, resulting in less reduction in the squareness ratio. However, examination by the present inventors has led to the conclusion that when a fluoride is used, the peripheries of the main phase particles cannot be easily covered in an even manner and the diffusion is deeper inside the main phase particles compared to a hydride, thus causing a notable reduction in the squareness ratio.

Using a hydride of a heavy rare earth element according to the invention results in fewer impurities being left after heat treatment, thus yielding a magnet with minimal deterioration of properties due to such impurities, compared to using a fluoride as according to the prior art. Due to these various factors, a magnet obtained according to the invention exhibits an adequate Br and excellent HcJ, has a sufficiently large squareness ratio and has minimal reduction in magnetic properties even when used at high temperature.

In the first step of the process for producing a magnet according to the invention, the sintered compact is preferably coated with a slurry comprising the heavy rare earth compound dispersed in a solvent, in order to adhere the heavy rare earth compound onto the sintered compact. A method of coating a slurry onto the sintered compact allows the heavy rare earth compound to be uniformly adhered onto the sintered compact. As a result, the heavy rare earth compound becomes evenly diffused by the heat treatment, allowing more satisfactory improvement in properties to be achieved.

Also, the mean particle size of the heavy rare earth compound adhered onto the sintered compact is preferably 100 nm-50 μm. This will allow even more satisfactory diffusion of the heavy rare earth compound to be achieved by the heat treatment.

Dy or Tb is especially preferred as the heavy rare earth element in the heavy rare earth compound. Dy and Tb tend to particularly improve the coercive force and as hydrides, and tend to produce a more satisfactory squareness ratio.

### EFFECT OF THE INVENTION

According to the invention it is possible to provide a process for producing a magnet that not only allows satisfactory Br and HcJ values to be achieved but can also yield a magnet with a sufficiently large squareness ratio, which is suitable for use at high temperature.

### BRIEF DESCRIPTION OF THE DRAWINGS

FIG. 1 is a flow chart showing the production steps for a rare earth magnet according to a preferred embodiment.

FIG. 2 is a plot diagram for values of Br with respect to DyH₂ deposit efficiency in different measuring samples.

FIG. 3 is a plot diagram for values of HcJ with respect to DyH₂ deposit efficiency in different measuring samples.

FIG. 4 is a plot diagram for values of Hk/HcJ with respect to DyH₂ deposit efficiency in different measuring samples.

FIG. 5 is a plot diagram for values of Br with respect to HcJ in different rare earth magnet samples.

### BEST MODE FOR CARRYING OUT THE INVENTION

Preferred modes of the invention will now be explained.

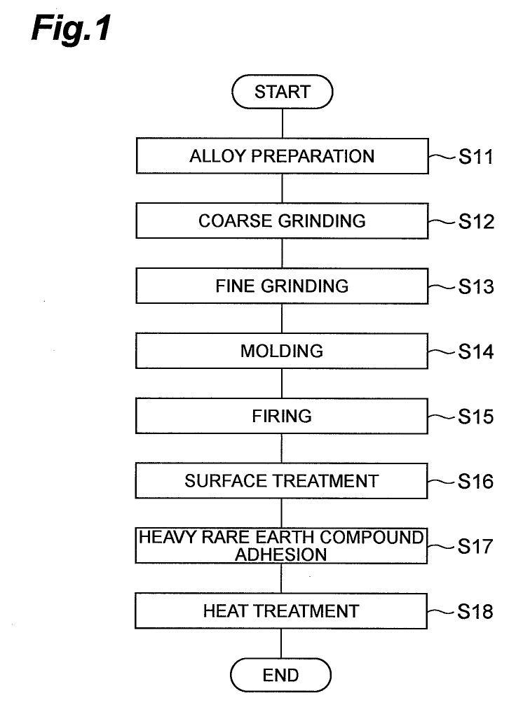

FIG. 1 is a flow chart showing the production steps for a magnet (rare earth magnet) according to a preferred embodiment.

For production of a rare earth magnet according to this embodiment, first an alloy is prepared that will yield a rare earth magnet having the desired composition (step S11). In this step, for example, a simple substance, alloy or compound, which contains the elements such as metals corresponding to the composition of the rare earth magnet, is melted under a vacuum or an inert gas atmosphere of argon or the like, and then the molten substance is used for an alloy production process such as casting or strip casting to produce an alloy having the desired composition.

The alloy may be a combination of two types, namely an alloy having the composition for the main phase of the rare earth magnet (main phase alloy) and an alloy having the composition for the grain boundary phase (grain boundary phase alloy).

The rare earth magnet used for the invention may be one composed mainly of Nd or Pr as the rare earth element, and is preferably one having a composition comprising a combination of a rare earth element with a transition element other than the rare earth element. Specifically, it is preferably one having an R—Fe—B based composition that includes at least one among Nd, Pr, Dy and Tb as the rare earth element (represented by “R”), and that contains B as an essential element at 1-12 atomic percent with the remainder Fe. If necessary, the rare earth magnet may also have a composition that further contains other elements such as Co, Ni, Mn, Al, Cu, Nb, Zr, Ti, W, Mo, V, Ga, Zn and Si.

The obtained alloy is then subjected to coarse grinding to produce particles with particle sizes of about several hundred μm (step S12). The coarse grinding of the alloy may be carried out using a coarse grinding machine such as a jaw crusher, brown mill, stamp mill or the like, or by absorbing the hydrogen in the alloy and then causing self-destructive grinding based on the difference in absorbed hydrogen amounts between the different phases (hydrogen absorption grinding).

Next, the powder obtained by the coarse grinding is further subjected to fine grinding (step S13) to obtain a starting powder for the rare earth magnet having a particle size of preferably about 1-10 μm and more preferably 3-5 μm (hereinafter also referred to simply as “starting powder”). The fine grinding may be carried out by subjecting the coarsely ground powder to further grinding using a fine grinding machine such as a jet mill, ball mill, vibrating mill, wet attritor or the like, while appropriately adjusting the conditions such as the grinding time.

When two different types of alloys, a main phase alloy and a grain boundary phase alloy, are prepared for production of the alloy, the coarse grinding and fine grinding may be carried out on both alloys and the two fine powders obtained thereby combined to prepare the starting powder.

The starting powder obtained in this manner is then molded into the desired shape (step S14). The molding is conducted in the presence of an applied magnetic field which produces a prescribed orientation in the starting powder. The molding may be press molding, for example. Specifically, after the starting powder has been packed into a die cavity, the packed powder is pressed between an upper punch and a lower punch to mold the starting powder into the prescribed shape. There are no particular restrictions on the shape of the compact obtained by molding, and it may be changed to cylindrical, planar, ring-shaped or the like, according to the intended shape of the rare earth magnet. The pressing during molding is preferably at 0.5-1.4 ton/cm². The applied magnetic field is preferably 12-20 kOe. The molding method may be dry molding wherein the starting powder is molded directly as described above, or wet molding wherein a slurry of the starting powder dispersed in a solvent such as an oil is molded.

Next, the compact is fired by heating at 1010-1110° C. for 2-6 hours in a vacuum or in the presence of an inert gas, for example (step S15). This causes the starting powder to undergo liquid phase sintering, to obtain a sintered compact with an improved volume ratio of the main phase (a sintered rare earth magnet).

After being worked into the appropriate and desired size and shape, the surface of the sintered compact is preferably treated with an acid solution (step S16). The acid solution used for the surface treatment is preferably a mixture of an alcohol with an aqueous solution of nitric acid, hydrochloric acid or the like. The surface treatment may also be carried out by immersing the sintered compact in the acid solution or spraying the sintered compact with the acid solution.

The surface treatment removes the dirt or oxide layer attached to the sintered compact to yield a clean surface, and is therefore advantageous for the heavy rare earth compound adhesion and diffusion described hereunder. From the viewpoint of achieving more satisfactory removal of the dirt or oxide layer, the surface treatment may be carried out with application of ultrasonic waves to the acid solution.

Next, the heavy rare earth compound containing the heavy rare earth element is adhered onto the surface of the surface treated sintered compact (step S17). The term “heavy rare earth element” refers to rare earth elements with high atomic numbers, and generally includes the rare earth elements from ₆₄Gd to ₇₁Lu. As heavy rare earth elements for the heavy rare earth compound to be adhered onto the sintered compact, there are preferred Gd, Dy, Tb, Ho, Er, Yb and Lu, with Dy and Tb being particularly preferred. According to this embodiment, the only heavy rare earth compounds used are hydrides of the heavy rare earth element, whereas heavy rare earth element compounds other than hydrides, such as oxides, halides or hydroxides, are not used. Specifically, the heavy rare earth compound is preferably a hydride, and most preferably DyH₂ or TbH₂. Although DyH₃ or the like may also be used as the hydride, DyH₂ or TbH₂, and especially DyH₂, is most preferred because of its excellent stability during storage and its excellent stability during formation of particles as described hereunder, which results in satisfactory manageability.

The heavy rare earth element hydride used may be one produced by the following method, for example. Specifically, the method employed may be one in which a heavy rare earth element metal is placed in a hydrogen atmosphere for hydrogen absorption and then subjected to dehydrogenation in an Ar or vacuum atmosphere to obtain a heavy rare earth element hydride. With hydrogen absorption at room temperature the hydride that is produced will be mainly RH₃ (R=heavy rare earth element), while hydrogen absorption at a high temperature of 250-500° C. will result in a hydride composed mainly of RH₂. The dehydrogenation, for both RH₃ and RH₂, may be carried out by treating the hydrogen-absorbed compound in a high-temperature atmosphere of 500-700° C. The produced hydrides can be confirmed by phase identification using X-ray diffraction, and by measuring the hydrogen content by gas analysis.

The heavy rare earth compound adhered onto the sintered compact is preferably in granular form, with a mean particle size of preferably 100 nm-50 μm, more preferably 1 μm-10 μm, even more preferably 1-5 μm and yet more preferably 1-3 μm. If the particle size of the heavy rare earth compound is less than 100 nm, the amount of heavy rare earth compound diffused in the sintered compact by the heat treatment will be excessive, potentially resulting in insufficient Br in the obtained rare earth magnet. If it is greater than 50 μm, on the other hand, the heavy rare earth compound will not diffuse easily in the sintered compact, and the HcJ may not be sufficiently improved. Adhesion of the heavy rare earth compound onto the sintered compact will be particularly satisfactory if the mean particle size of the heavy rare earth compound is less than 5 μm, and will tend to result in even better improvement in the HcJ value.

The method of adhering the heavy rare earth compound onto the sintered compact may be, for example, a method in which particles of the heavy rare earth compound are directly blasted onto the sintered compact, a method in which a solution of the heavy rare earth compound in a solvent is applied onto the sintered compact, or a method in which a slurry of the heavy rare earth compound particles dispersed in a solvent is applied onto the sintered compact. Of these, the method of applying a slurry onto the sintered compact is preferred since it allows the heavy rare earth compound to be more evenly adhered onto the sintered compact and results in satisfactory diffusion in the heat treatment described hereunder.

The solvent used for the slurry is preferably an alcohol, aldehyde, ketone or the like that can evenly disperse the heavy rare earth compound without dissolving it, with ethanol being preferred.

The method for applying the slurry onto the sintered compact may involve immersing the sintered compact in the slurry, or placing the sintered compact in the slurry and agitating it together with a specific medium. The latter method may be a ball mill process, for example. Agitation together with a medium in this manner can more reliably produce adhesion of the heavy rare earth compound onto the sintered compact, and will allow the amount of adhesion of the heavy rare earth compound to be stabilized by reducing the degree of flaking after adhesion. This method also allows large amounts of sintered compact to be treated at once. Since the former method involving immersion may be more advantageous for adhesion depending on the shape of the sintered compact, in practice these methods may be selected as deemed appropriate. Application can also be accomplished by dropping the slurry onto the sintered compact.

When a slurry is used, the content of the heavy rare earth compound in the slurry is preferably 5-75 wt %, more preferably 10-50 wt % and even more preferably 10-30 wt %. If the content of the heavy rare earth compound in the slurry is too low or too high, it may be difficult to achieve uniform adhesion of the heavy rare earth compound onto the sintered compact, potentially making it impossible to obtain a sufficient squareness ratio. If it is too high, the surface of the sintered compact may be roughened and it may be difficult to form a plating for improved corrosion resistance of the obtained magnet. If it is too low, on the other hand, it may be difficult to achieve the desired coating amount of the heavy rare earth compound on the sintered compact, potentially preventing the desired improvement in properties.

Components other than heavy rare earth compound may also be included in the slurry if necessary. As examples of other components to be included in the slurry there may be mentioned dispersing agents and the like, to prevent aggregation of the heavy rare earth compound particles.

The heavy rare earth compound will adhere onto the sintered compact by the methods described above, and the coverage of the heavy rare earth compound is preferably within a specific range from the viewpoint of obtaining satisfactory improvement in the magnetic properties. Specifically, the coverage (deposit efficiency: %) of the heavy rare earth compound with respect to the weight of the rare earth magnet (the total weight of the sintered compact and heavy rare earth compound) is preferably 0.1-3 wt %, more preferably 0.1-2 wt % and even more preferably 0.2-1 wt %.

The heavy rare earth compound-adhered sintered compact is then subjected to heat treatment (step S18). This will allow the heavy rare earth compound adhered on the surface of the sintered compact to diffuse into the sintered compact. The heat treatment may be carried out in a two-stage step, for example. In this case, heat treatment is preferably carried out for 10 minutes-10 hours at about 800-1000° C. in the first stage, and then for 1-4 hours at about 500-600° C. in the second stage. In this two-stage heat treatment, diffusion of the heavy rare earth compound is mainly produced in the first stage, while the heat treatment in the second stage serves as “aging treatment” to help improve the magnetic properties (especially HcJ). However, the heat treatment does not necessarily need to be carried out in two stages and will be sufficient if it at least causes diffusion of the heavy rare earth compound.

Although the heat treatment causes diffusion of the heavy rare earth compound from the surface to the interior of the sintered compact, it is believed that the heavy rare earth compound diffuses primarily along the boundaries of the main phase particles composing the sintered compact. As a result, the heavy rare earth element of the heavy rare earth compound in the obtained magnet becomes maldistributed at the fringe regions or grain boundaries of the main phase particles, thus forming a structure wherein the main phase particles are covered by a layer of the heavy rare earth element.

Next, if necessary, the heavy rare earth compound-diffused sintered compact is cut to the desired size and subjected to surface treatment to obtain the rare earth magnet. The obtained rare earth magnet may also be provided with a protective layer on its surface to prevent deterioration, such as a plating layer, oxidation layer or resin layer.

In the process for producing a rare earth magnet according to this embodiment, as explained above, adhesion and heat treatment of the heavy rare earth compound are carried out after forming the sintered compact, thus allowing the heavy rare earth element to selectively diffuse primarily at the fringe regions and grain boundaries of the main phase particles composing the magnet, and thereby improving the HcJ while maintaining an adequate Br value. Also, since a hydride is used as the heavy rare earth compound according to this embodiment, it is possible to obtain a rare earth magnet with a high squareness ratio and minimal deterioration in properties due to residual impurities from the heavy rare earth compound. As a result, this embodiment can provide a rare earth magnet with minimal reduction in magnetic properties even when used at high temperature.

### EXAMPLES

The present invention will now be explained in greater detail through the following examples, with the understanding that these examples are in no way limitative on the invention.

### Production of Rare Earth Magnet

### Example 1

First, a starting alloy was prepared to produce a rare earth magnet having the composition 24.00 wt % Nd—1.00 wt % Dy—5.30 wt % Pr—0.450 wt % Co—0.18 wt % Al—0.06 wt % Cu—1.00 wt % B—bal.Fe. Two starting alloys were prepared, a main phase alloy primarily for formation of the main phase of the magnet, and a grain boundary alloy primarily for formation of the grain boundary. Next, the starting alloys were subjected to coarse grinding by hydrogen grinding and then jet mill grinding with high pressure N₂ gas to produce fine powders each with mean particle sizes of D=4 μm.

The fine powder for the main phase alloy and the fine powder for the grain boundary alloy were mixed in a proportion of 95:5, respectively, to prepare a magnetic powder as the starting powder for the rare earth magnet. The magnetic powder was then used for magnetic field molding under conditions with a molding pressure of 1.2 t/cm² and an orienting magnetic field of 15 kOe, to obtain a compact. The obtained compact was fired under conditions of 1060° C., 4 hours to obtain a rare earth magnet sintered compact having the composition mentioned above.

The obtained sintered compact was immersed for 3 minutes in a 3 wt % nitric acid/ethanol mixed solution and then treated twice by immersion in ethanol for 1 minute for surface treatment of the sintered compact. All of these treatments were carried out with application of ultrasonic waves. Next, the surface-treated sintered compact was immersed in a slurry comprising DyH₂ (mean particle size D=10 μm) dispersed in ethanol (DyH₂ content=50 wt %) while applying ultrasonic waves, and then the slurry-adhered sintered compact was dried under a nitrogen atmosphere. This caused the DyH₂ to adhere onto the surface of the sintered compact.

The Dy hydride used was produced by heating Dy powder at 350° C. for 1 hour under a hydrogen atmosphere for absorption, and then treating it for 1 hour at 600° C. under an Ar atmosphere. The hydride obtained in this manner was measured by X-ray diffraction, and DyH₂ was identified by analogical inference from ErH₂ according to ASTM Card 47-978.

The dried sintered compact was subjected to heat treatment at 800° C. for 1 hour and then to aging treatment at 540° C. for 1 hour to obtain a rare earth magnet. The size of the obtained rare earth magnet was 2 mm (thickness in the magnetic anisotropy direction)×14 mm×10 mm.

### Examples 2 and 3

Rare earth magnets were produced in the same manner as Example 1, except that heat treatment of the dried sintered compact was carried out at 900° C. (Example 2) and 1000° C. (Example 3).

### Comparative Examples 1-3

Rare earth magnets were produced in the same manner as Example 1, except that DyF₃ was used instead of DyH₂, and heat treatment of the dried sintered compact was carried out at 800° C. (Comparative Example 1), 900° C. (Comparative Example 2) and 1000° C. (Comparative Example 3).

### Comparative Example 4

After obtaining a sintered compact for a rare earth magnet in the same manner as Example 1, it was subjected to heat treatment at 900° C. for 1 hour and then to aging treatment at 540° C. for 1 hour to obtain a rare earth magnet.

### [Evaluation of Physical Properties]

(Measurement of Heavy Rare Earth Compound Coverage on Rare Earth Magnet Sintered Compact)

First, the difference in coverage of the sintered compacts was evaluated, as according to the type of heavy rare earth compound (Dy compound) adhered to the rare earth magnet sintered compact (DyH₂: Examples 1-3, DyF₃: Comparative Examples 1-3). That is, the weight before immersion of the sintered compact in the Dy compound slurry and the weight after immersion in the slurry and drying were measured during the rare earth magnet production process described above, and these weights were compared to determine the amount of adhesion of the Dy compound onto the sintered compact, and used for calculation of the amount of adhesion of the Dy compound per unit surface area of the sintered compact (g/cm²). The result was used to derive the amount of Dy element per unit surface area adhering to the sintered compact. Table 1 shows the average values for the results obtained by several measurements for DyH₂ and DyF₃.

TABLE 1

| | Coverage of Dy | Coverage of Dy |
|---|---|---|
| | compound per unit | element per unit |
| Dy compound | surface area | surface area |
| DyF₃: Comp. Examples 1-3 | 5.4 × 10⁻³ | 4.0 × 10⁻³ |
| DyH₂: Examples 1-3 | 6.0 × 10⁻³ | 5.9 × 10⁻³ |

Table 1 shows that DyH₂ adhered more easily than DyF₃ onto the rare earth magnet sintered compacts. Also, since DyH₂ has a larger amount of Dy per weight compared to DyF₃, it is more advantageous for adhesion of Dy element onto sintered compacts.

(Measurement of Dy Content of Rare Earth Magnets)

The rare earth magnets of the examples and comparative examples were each stacked in 6 layers in the thickness direction and used as measuring samples, and the Dy contents of the measuring samples were measured by fluorescent X-ray analysis. This procedure was carried out to determine the Dy contents of the rare earth magnets (sintered compacts) in which Dy had been diffused by heat treatment after adhesion of the Dy compounds. The results are shown in Table 2.

(Evaluation of Magnetic Properties)

A BH tracer was used to measure the magnetic properties of measuring samples obtained using the rare earth magnets of the examples and comparative examples. The residual flux density (Br), coercive force (HcJ) and squareness ratio (Hk/HcJ) of each measuring sample was determined based on the results.

Using as a reference the measuring sample for the rare earth magnet of Comparative Example 4, which had no Dy compound adhesion, the change in Dy content (ΔDy), the change in Br (d(Br)), the change in HcJ (d(HcJ)) and the change in squareness ratio (d(Hk/HcJ)) were determined for each of the rare earth magnet measuring samples of the examples and comparative examples, with respect to the values of the properties obtained with the reference sample. The results are summarized in Table 2. The changes in the magnetic properties (d(Br), d(HcJ), d(Hk/HcJ)) are the values for the amount of change per 0.1 wt % change in Dy content.

TABLE 2

| | | | | | Magnetic properties | | | | | |
|---|---|---|---|---|---|---|---|---|---|---|
| | Dy | Heat | Dy content | Δ Dy | Br | HcJ | Hk/HcJ | d(Br) | d(HcJ) | d(Hk/HcJ) |
| | compound | treatment | (wt %) | (wt %) | (kG) | (kOe) | (%) | (kG) | (kOe) | (%) |
| Comp. Ex. 4 | None | 900° C. · 1 h | 0.975 | — | 14.15 | 14.50 | 96.38 | — | — | — |
| Example 1 | DyH₂ | 800° C. · 1 h | 1.314 | 0.339 | 13.74 | 16.28 | 94.76 | −0.12 | 0.53 | −0.48 |
| Example 2 | DyH₂ | 900° C. · 1 h | 1.325 | 0.350 | 13.74 | 17.74 | 94.80 | −0.12 | 0.93 | −0.45 |
| Example 3 | DyH₂ | 1000° C. · 1 h | 1.433 | 0.458 | 13.73 | 18.20 | 95.57 | −0.09 | 0.81 | −0.18 |
| Comp. Ex. 1 | DyF₃ | 800° C. · 1 h | 1.118 | 0.143 | 13.82 | 14.63 | 92.58 | −0.23 | 0.09 | −2.70 |
| Comp. Ex. 2 | DyF₃ | 900° C. · 1 h | 1.424 | 0.449 | 13.77 | 16.53 | 87.31 | −0.09 | 0.45 | −2.00 |
| Comp. Ex. 3 | DyF₃ | 1000° C. · 1 h | 1.868 | 0.893 | 13.61 | 18.00 | 88.30 | −0.06 | 0.39 | −0.90 |

According to Table 2, the rare earth magnets of Examples 1-3, which employed DyH₂ as the Dy compound adhered to the sintered compact, had significantly improve HcJ values compared to Comparative Example 4 which had no Dy compound adhering to the sintered compact. Also, the rare earth magnets of Examples 1-3 exhibited about the same reduction in Br compared to Comparative Example 4 as did Comparative Examples 1-3 which employed DyF₃ as the Dy compound, but HcJ was significantly improved and the reduction in the squareness ratio was much smaller. This confirmed that using a heavy rare earth element hydride as the heavy rare earth compound adhered to the sintered compact can improve the HcJ value while preventing reduction in Br, and can also maintain a high squareness ratio.

### Production of Rare Earth Magnet

### Examples 4-6

First, starting alloys were prepared to produce a rare earth magnet having the composition 26.50 wt % Nd—3.50 wt % Dy—0.50 wt % Co—0.22 wt % Al—0.07 wt % Cu—0.92 wt % B—bal.Fe. Two starting alloys were prepared, a main phase alloy primarily for formation of the main phase of the magnet, and a grain boundary alloy primarily for formation of the grain boundary. Next, the starting alloys were subjected to coarse grinding by hydrogen grinding and then jet mill grinding with high pressure N₂ gas to produce fine powders each with mean particle sizes of D=4 μm.

The fine powder for the main phase alloy and the fine powder for the grain boundary alloy were mixed in a proportion of 95:5, respectively, to prepare a magnetic powder as the starting powder for the rare earth magnet. The magnetic powder was then used for magnetic field molding under conditions with a molding pressure of 1.2 t/cm² and an orienting magnetic field of 15 kOe, to obtain a compact. The obtained compact was fired under conditions of 1010° C., 4 hours to obtain a rare earth magnet sintered compact having the composition mentioned above. The obtained sintered compact was cut to dimensions of 15×8.6×2.4 (mm).

The sintered compact was immersed for 3 minutes in a 3 wt % nitric acid/ethanol mixed solution and then treated twice by immersion in ethanol for 1 minute for surface treatment of the sintered compact. All of these treatments were carried out with application of ultrasonic waves.

DyH₂ powders with mean particle sizes of (1) 33.2 μm, (2) 4.9 μm and (3) 2.5 μm were prepared as DyH₂ compounds for coating onto the sintered compacts. The starting powder for DyH₂ was a Dy metal powder prepared under same conditions as Example 1. For (1), the starting powder was pulverized with a mortar, and its hydrogen content was analyzed to be 11,480 ppm. For (2), the DyH₂ starting powder was pulverized for 12 hours in an ethanol solution using a ball mill (BM) with a ⅛-inch SUS medium, and for (3) the DyH₂ starting powder was pulverized for 96 hours in an ethanol solution using a ball mill (BM) with a ⅛-inch SUS medium. The DyH₂ powders were added to ethanol to DyH₂ concentrations of 35 wt %, to prepare slurries for coating onto sintered compacts.

Next, the surface-treated sintered compacts were immersed for 2 minutes in slurries comprising the DyH₂ compounds of (1)-(3) and then raised out, and the slurry-adhered sintered compacts were dried under a nitrogen atmosphere. This caused the DyH₂ to adhere onto the surface of each sintered compact.

The sintered compacts were heat treated at 1000° C. for 1 hour and then further subjected to aging treatment at 540° C. for 1 hour, to obtain rare earth magnets employing the DyH₂ powders with mean particle sizes of (1) 33.2 μm (Example 4), (2) 4.9 μm (Example 5) and (3) 2.5 μm (Example 6).

### Example 7

First, a surface-treated sintered compact was prepared in the same manner as Examples 4-6. The Dy hydride coated onto the sintered compact was then prepared in the following manner. First, the Dy metal powder was subjected to 1 hour of hydrogen absorption treatment at room temperature, and then to 1 hour of treatment at 600° C. under an Ar atmosphere to obtain a starting powder. The hydrogen content of the starting powder was analyzed to be 17,320 ppm. These results suggested that the obtained starting powder was composed of DyH₃. The obtained Dy hydride (DyH₃) starting powder was then pulverized for 96 hours with a ball mill in the same manner as Example 6 described above, to obtain a DyH₃ powder with a mean particle size of 2.4 μm.

Using the sintered compact and DyH₃ powder, the DyH₃ was adhered onto the sintered compact in the same manner as Examples 4-6 and subjected to heat treatment and aging treatment to obtain a rare earth magnet for Example 7.

### Comparative Example 5

A rare earth magnet was obtained in the same manner as Examples 4-6, but without adhering DyH₂.

### [Evaluation of Physical Properties]

(Measurement of Dy Hydride Adhesion (Deposit Efficiency and Adhesion Weight Per Unit Area))

The weights of the Dy hydrides (DyH₂ or DyH₃) adhering to the rare earth magnets of Examples 4-7 and Comparative Example 5 were measured by first measuring the weight of the sintered compact before adhesion of the Dy hydride and the weight of the rare earth magnet obtained after adhesion of the Dy hydride, and subtracting the former weight from the latter weight. The results were used to determine the deposit efficiency (%) of Dy hydride with respect to the rare earth magnet weight, and the adhesion weight of the Dy hydride per 1 cm² surface area of the rare earth magnet (mg/cm²).

Samples were formed from the rare earth magnets of Examples 4-7 and Comparative Example 5 and measured in the manner described above. The average values for the Dy hydride deposit efficiency and Dy hydride adhesion weight for each of the rare earth magnets of the examples and comparative examples were calculated from the results for the multiple samples. The results are shown in Table 3.

(Evaluation of Magnetic Properties)

The rare earth magnets of Examples 4-7 and Comparative Example 5 were stacked in groups of three in the thickness direction to prepare measuring samples, and their magnetic properties were measured with a BH tracer. The residual flux density (Br), coercive force (HcJ) and squareness ratio (Hk/HcJ) of each measuring sample was determined based on the results.

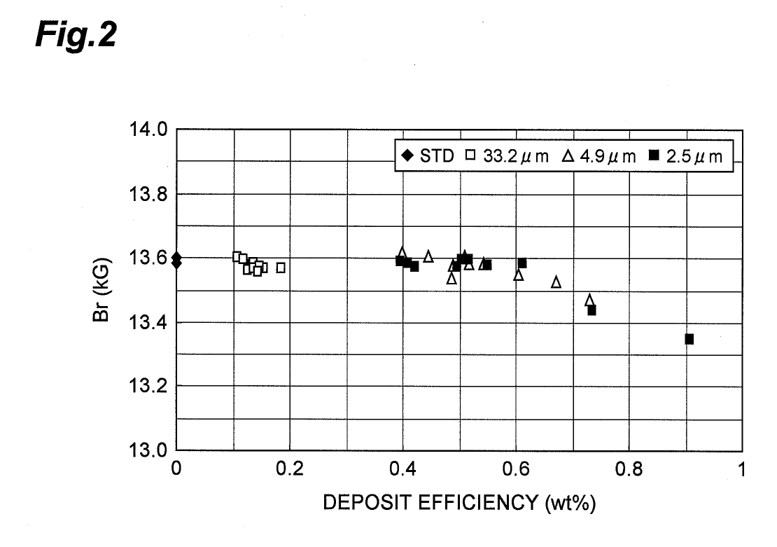

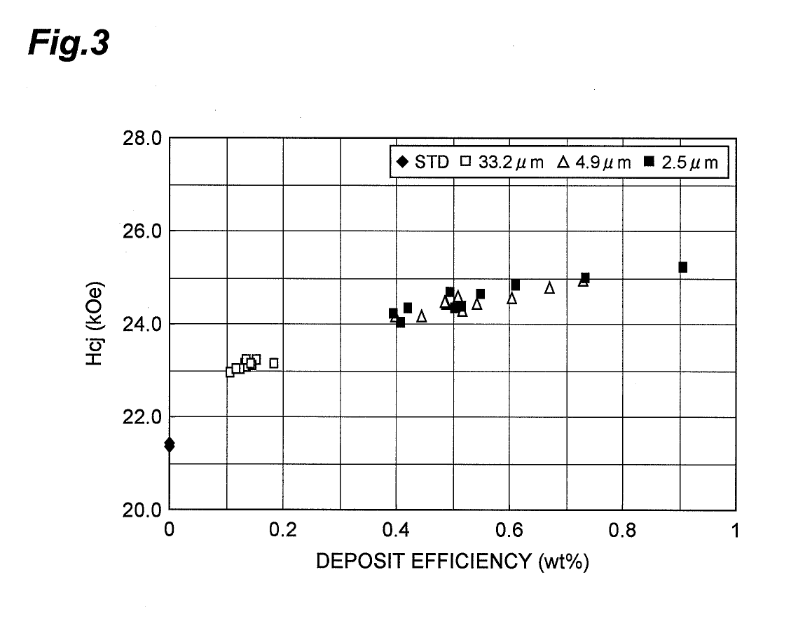

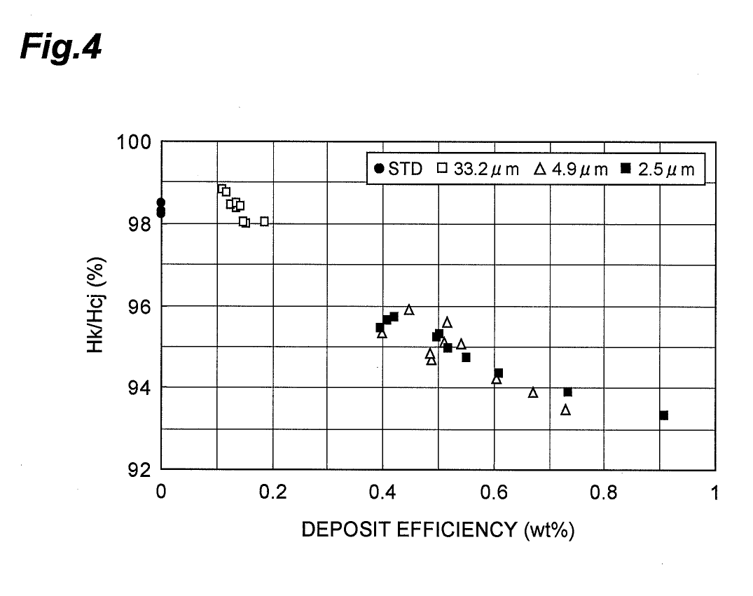

The magnetic properties were measured for all of the samples formed for “Measurement of Dy hydride coverage” described above. The obtained results are shown in FIG. 2, FIG. 3 and FIG. 4. FIG. 2 is a plot diagram for values of Br with respect to Dy hydride deposit efficiency in different measuring samples, FIG. 3 is a plot diagram for values of HcJ with respect to Dy hydride deposit efficiency in different measuring samples, and FIG. 4 is a plot diagram for values of Hk/HcJ with respect to Dy hydride deposit efficiency in different measuring samples. In these diagrams, STD represents the data obtained with the rare earth magnet of Comparative Example 5 which had no Dy hydride adhesion. Table 3 shows the average values of Dy hydride adhesion, Br, HcJ and Hk/HcJ obtained from the results of the multiple measuring samples for each of the rare earth magnets of the examples and comparative examples. Table 3 also shows the Dy contents of the rare earth magnets (sintered compacts) measured by fluorescent X-ray analysis in the same manner as Example 1 described above.

TABLE 3

| | Dy hydride | | | | | | | |
|---|---|---|---|---|---|---|---|---|
| | | Particle | | | Dy | Magnetic properties | | |
| | | size | Deposit efficiency | | content | | HcJ | Hk/HcJ |
| | Type | (μm) | (wt %) | (mg/cm²) | (wt %) | Br (kG) | (kOe) | (%) |
| Comp. Ex. 5 | — | — | — | — | 3.49 | 13.60 | 21.39 | 98.33 |
| Example 4 | DyH₂ | 33.2 | 0.184 | 0.873 | 3.60 | 13.57 | 23.09 | 98.37 |
| Example 5 | DyH₂ | 4.9 | 0.539 | 3.393 | 3.96 | 13.57 | 24.49 | 94.81 |
| Example 6 | DyH₂ | 2.5 | 0.555 | 3.492 | 3.99 | 13.55 | 24.55 | 94.86 |
| Example 7 | DyH₃ | 2.4 | 0.560 | 3.526 | 3.85 | 13.53 | 24.13 | 95.01 |

Based on FIGS. 2, 3 and 4 and Table 3, it was confirmed that the rare earth magnets of the Dy hydride-adhered Examples 4-7 had significantly improved HcJ values while maintaining satisfactory Br and Hk/HcJ values, compared to the rare earth magnet of Comparative Example 5 which had no Dy hydride adhesion. Also, the results for the rare earth magnets of Examples 4, 5 and 6 demonstrated that satisfactory adhesion of DyH₂ and especially improved HcJ is achieved when the particle size of the DyH₂ powder adhered to the sintered compact is no greater than 5 μm and especially no greater than 3 μm.

Moreover, based on comparison between Example 6 and Example 7 which had the same Dy hydride particle sizes, it was found that using DyH₂ (Example 6) resulted in an increased actual Dy content in the sintered compact and greater improvement in the magnetic properties (especially HcJ), even though the adhesion of DyH₃ (Example 7) was greater. The oxygen contents of the DyH₂ and DyH₃ adhered to the sintered compact were also analyzed, and found to be 6490 ppm for the former and 9830 ppm for the latter. This suggests that DyH₂ is more chemically stable than DyH₃ and its diffusion into the interior of the sintered compact is less inhibited by oxidation during heat treatment, so that the magnetic properties are greatly improved even with a smaller amount of Dy hydride.

### Production of Rare Earth Magnets

### Examples 8 and 9

First, surface-cleaned sintered compacts for formation of rare earth magnets were produced in the same manner as Examples 4-6.

For Example 8, DyH₂ powder with a mean particle size of 2.5 μm was placed in a SUS container and the sintered compact was embedded in the powder for direct adhesion of the DyH₂ powder onto the entire surface of the sintered compact. For Example 9, there was prepared a slurry of DyH₂ powder with a mean particle size of 2.5 μm, containing ethanol as the solvent, and the sintered compact was loaded into the slurry for 3 minutes of stirring with a ball mill to adhere the DyH₂ onto the sintered compact (ball mill method).

The DyH₂-adhered sintered compacts obtained in Examples 8 and 9 were then subjected to heat treatment at 1000° C. for 1 hour and then to aging treatment at 540° C. for 1 hour to obtain rare earth magnets. Examples 8 and 9 were adjusted to obtain the DyH₂ deposit efficiencies shown in Table 4 below for multiple rare earth magnets of each.

### [Evaluation of Physical Properties]

(Evaluation of Magnetic Properties)

The rare earth magnets obtained in Examples 8 and 9 were stacked in groups of three in the thickness direction to prepare measuring samples, and their magnetic properties were measured with a BH tracer. The residual flux density (Br) and coercive force (HcJ) of each measuring sample was determined based on the results.

The results are summarized in Table 4. Table 4 also shows the results obtained with the rare earth magnet of Comparative Example 5 described above.

TABLE 4

| | | DyH₂ deposit | | |
|---|---|---|---|---|
| | Application | efficiency | Br | HcJ |
| | method | (%) | (kG) | (kOe) |
| Comp. Ex. 5 | No application | 0 | 13.60 | 21.39 |
| Example 8 | Powder application | 1.142 | 13.03 | 24.84 |
| | | 1.116 | 13.09 | 25.55 |
| | | 0.592 | 13.20 | 24.10 |
| | | 0.610 | 13.00 | 24.32 |
| Example 9 | Ball mill method | 1.690 | 13.13 | 25.97 |
| | | 0.577 | 13.45 | 24.57 |
| | | 0.449 | 13.48 | 24.14 |

Based on Table 4, it was confirmed that Example 9 wherein DyH₂ was adhered by the ball mill method exhibited high magnetic properties with the same level of DyH₂ deposit efficiency as Example 8 which had direct adhesion of DyH₂.

### Production of Rare Earth Magnets

### Examples 10-13

First, surface-cleaned sintered compacts for formation of rare earth magnets were produced in the same manner as Examples 4-6, except that the starting alloy was prepared to yield rare earth magnets having the composition 25.50 wt % Nd—4.50 wt % Dy—0.50 wt % Co—0.22 wt % Al—0.07 wt % Cu—1.00 wt % B—bal.Fe, and the dimensions of the sintered compacts were 15×6×2.3 (mm).

Next, for Example 10, a slurry with a DyH₂ concentration of 25 wt % was prepared using DyH₂ powder with a mean particle size (d0.5) of 2.5 μm, containing ethanol as the solvent, and the sintered compact was loaded into the slurry for 3 minutes of stirring with a ball mill at 200 rpm to adhere the DyH₂ onto the sintered compact (ball mill method).

For Examples 11-13, slurries with DyH₂ concentrations of 25 wt % (Example 11), 18 wt % (Example 12) and 15 wt % (Example 13) were prepared using DyH₂ powder with a mean particle size (d0.5) of 2.5 μm, containing ethanol as the solvent, the sintered compacts were immersed for 2 minutes in the slurries and then raised out, and the slurry-adhered sintered compacts were dried under a nitrogen atmosphere for adhesion of DyH₂ onto the sintered compacts (dip method).

Each DyH₂-adhered sintered compact was subjected to heat treatment at 1000° C. for 1 hour and then to aging treatment at 540° C. for 1 hour to obtain rare earth magnets for Examples 10-13.

### [Evaluation of Physical Properties]

(Measurement of Dy Coverage (Deposit Efficiency))

After preparing 100 samples of each of the rare earth magnets of Examples 10-13, the Dy deposit efficiency (%) values were measured for each in the manner described above. The average values and standard deviations for the Dy deposit efficiencies obtained for the 100 rare earth magnet samples corresponding to the examples were also determined. The results are shown in Table 5.

TABLE 5

| | | DyH₂ | Average | |
|---|---|---|---|---|
| | DyH₂ | concentration | deposit | Standard |
| | adhesion | of slurry | efficiency | deviation |
| | method | (wt %) | (wt %) | (wt %) |
| Example 10 | Ball mill | 25 | 0.210 | 0.026 |
| Example 11 | Dip | 25 | 0.476 | 0.082 |
| Example 12 | Dip | 18 | 0.384 | 0.051 |
| Example 13 | Dip | 15 | 0.306 | 0.040 |

Based on Table 5, it was confirmed that DyH₂ can be adhered by both ball mill and dip methods, and that the deposit efficiency can also be adjusted by changing the DyH₂ concentration of the slurry. Moreover, it was demonstrated that using the ball mill method as in Example 10 produced a smaller standard deviation in the deposit efficiency compared to the dip method used for Examples 11-13, when using slurries of the same concentration, and thus allows the desired deposit efficiency to be more easily achieved.

### Production of Rare Earth Magnets

### Examples 14-16

First, surface-cleaned sintered compacts for formation of rare earth magnets for Examples 14-16 were produced in the same manner as Examples 4-6, except that starting alloys were prepared to yield rare earth magnets having the compositions 29.70 wt % Nd—0.50 wt % Dy—0.50 wt % Co—0.18 wt % Al—0.06 wt % Cu—bal.Fe (Example 14), 29.50 wt % Nd—1.00 wt % Dy—0.50 wt % Co—0.18 wt % Al—0.06 wt % Cu—bal.Fe (Example 15) and 29.30 wt % Nd—2.00 wt % Dy—0.50 wt % Co—0.18 wt % Al—0.06 wt % Cu—bal.Fe (Example 16), and the dimensions of the sintered compacts were 15×6×2.3 (mm).

Next, each sintered compact was immersed for 2 minutes in a slurry of DyH₂ powder with a mean particle size of 2.5 μm, containing ethanol as the solvent, for adhesion of DyH₂ onto the sintered compact. For production of rare earth magnets for Examples 14-16, samples were prepared using slurries with different DyH₂ concentrations. A comparative sample for contrast with the examples was also prepared, which had no DyH₂ adhesion on the sintered compact.

The DyH₂-adhered sintered compact samples and the comparative sample were subjected to heat treatment at 1000° C. for 1 hour and then to aging treatment at 540° C. for 1 hour to obtain rare earth magnet samples with different DyH₂ deposit efficiencies for Examples 14-16. The DyH₂ deposit efficiencies for each of the samples of Examples 14-16 are shown in Table 6 below.

### [Evaluation of Physical Properties]

(Evaluation of Magnetic Properties)

The rare earth magnet samples obtained in Examples 14-16 and the comparative sample were stacked in groups of three in the thickness direction to prepare measuring samples, and their magnetic properties were measured with a BH tracer. The residual flux density (Br) and coercive force (HcJ) of each measuring sample was determined based on the results.

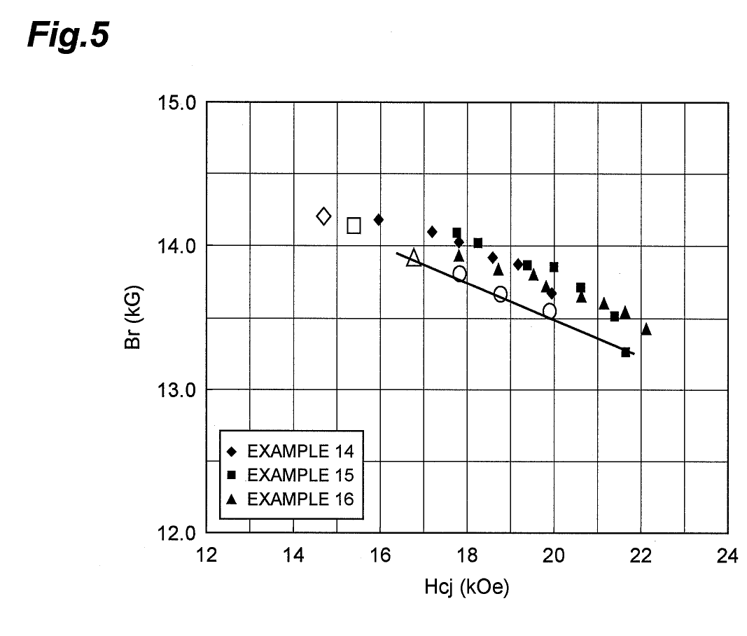

The results are shown in FIG. 5 and Table 6. FIG. 5 is a plot diagram for values of Br with respect to HcJ, obtained with the samples corresponding to each rare earth magnet. The white symbols with the same shapes as the examples in FIG. 5 are the results obtained for the comparative samples using the sintered compacts of each of the examples.

The white circles plotted in FIG. 5 represent measurement of the magnetic properties for three different sintered compacts with different Dy contents in the starting alloys used in Example 16 to produce compositions with Dy contents of 2.5 wt %, 3.0 wt % and 3.5 wt %, without adhesion of Dy hydride. These sintered compacts were used as reference samples. The line running through the plotted white circles representing the reference samples may be considered a reference line for the change in magnetic properties due only to the change in Dy content of the sintered compact given the same composition as Example 16, or in other words, the reference for magnetic properties obtained without Dy hydride adhesion.

TABLE 6

| | Example 14 | | | Example 15 | | | Example 16 | | |
|---|---|---|---|---|---|---|---|---|---|
| | DyH₂ deposit | | | DyH₂ deposit | | | DyH₂ deposit | | |
| | efficiency | Br | HcJ | efficiency | Br | HcJ | efficiency | Br | HcJ |
| Sample | (%) | (kG) | (kOe) | (%) | (kG) | (kOe) | (%) | (kG) | (kOe) |
| Comparison | 0 | 14.2 | 14.68 | 0 | 14.13 | 15.41 | 0 | 13.92 | 16.76 |
| 1 | 0.194 | 14.18 | 15.95 | 0.203 | 14.09 | 17.78 | 0.176 | 13.93 | 17.81 |
| 2 | 0.295 | 14.09 | 17.18 | 0.351 | 14.02 | 18.27 | 0.219 | 13.84 | 18.73 |
| 3 | 0.648 | 14.03 | 17.79 | 0.598 | 13.86 | 19.41 | 0.258 | 13.81 | 19.53 |
| 4 | 0.958 | 13.92 | 18.59 | 0.793 | 13.85 | 20.01 | 0.525 | 13.72 | 19.83 |
| 5 | 1.288 | 13.87 | 19.16 | 1.206 | 13.71 | 20.63 | 0.610 | 13.65 | 20.62 |
| 6 | 1.892 | 13.68 | 19.93 | 1.852 | 13.50 | 21.40 | 0.856 | 13.60 | 21.16 |
| 7 | — | — | — | 2.418 | 13.26 | 21.65 | 1.113 | 13.54 | 21.62 |
| 8 | — | — | — | — | — | — | 1.440 | 13.42 | 22.14 |

Based on the results shown in FIG. 5 and Table 6, it was confirmed, first of all, that the magnetic properties obtained with the comparative samples employing sintered compacts corresponding to each of the examples fell along roughly the same line as those obtained with the reference samples. It was shown that the rare earth magnets of the examples which had DyH₂ adhesion exhibited magnetic properties above the line. This demonstrated that adhesion of DyH₂ produces magnetic properties that are vastly superior to the magnetic properties of the sintered compact itself. Also, FIG. 5 and Table 6 shows that particularly excellent magnetic properties are obtained when the DyH₂ deposit efficiency is within a specified range, specifically 0.1-3 wt %, more preferably 0.1-2 wt % and even more preferably 0.2-1.0 wt %.

Moreover, the Dy contents of the sintered compacts of the comparative sample of the rare earth magnet corresponding to Example 16, samples 1, 3 and 5 and the aforementioned three reference samples, were measured by the same fluorescent X-ray analysis as in Example 1, to determine the actual values for the Dy contents of the sintered compacts of the samples. The obtained results are shown in Table 7, together with the magnetic properties (Br and HcJ) obtained for each sample.

TABLE 7

| | | DyH₂ deposit | Dy | | |
|---|---|---|---|---|---|
| | | efficiency | content | Br | HcJ |
| | Sample | (%) | (%) | (kG) | (kOe) |
| Example 16 | Comparison | 0 | 2.03 | 13.92 | 16.76 |
| | 1 | 0.176 | 2.19 | 13.93 | 17.81 |
| | 3 | 0.258 | 2.26 | 13.81 | 19.53 |
| | 5 | 0.610 | 2.58 | 13.65 | 20.62 |
| Reference | Dy 2.5 wt % | 0 | 2.51 | 13.80 | 17.85 |
| sample | Dy 3.0 wt % | 0 | 3.12 | 13.66 | 18.78 |
| | Dy 3.5 wt % | 0 | 3.59 | 13.54 | 19.90 |

As shown in Table 7, the rare earth magnets of the examples obtained by adhering DyH₂ to the sintered compacts exhibited high magnetic properties (especially coercive force), despite having lower actual Dy contents in the sintered compacts, compared to the reference samples which had increased Dy contents in the sintered compacts themselves. A rare earth magnet according to the examples can therefore provide high magnetic properties more conveniently and at lower cost than by increasing the Dy content of the sintered compact itself.

1. A process for producing a magnet characterized by comprising
a first step in which a heavy rare earth compound containing a heavy rare earth element is adhered onto a rare earth magnet sintered compact, and
a second step in which the heavy rare earth compound-adhered sintered compact is subjected to heat treatment,
wherein the heavy rare earth compound is a hydride of the heavy rare earth element.

2. A process for producing a magnet according to claim 1, characterized in that in the first step, a slurry of the heavy rare earth compound dispersed in a solvent is applied onto the sintered compact.

3. A process for producing a magnet according to claim 1, characterized in that the mean particle size of the heavy rare earth compound is 100 nm-50 μm.

4. A process for producing a magnet according to claim 1, characterized in that the heavy rare earth element is Dy or Tb.
